(19) United States
(12) Patent Application Publication
(10) Pub. No.: US 2004/0183230 A1
(43) Pub. Date: Sep. 23, 2004

(54) Novel method for manufacturing modified nylon 6T molded articles with improved temperature resistance

(75) Inventors: Ken Chen, (US); Hong Bing Tsai, (US)

Correspondence Address: TROXELL LAW OFFICE PLLC, 5205 LEESBURG PIKE, SUITE 1404, FALLS CHURCH, VA, 22041, US

(73) Assignee: Plastron Precision Co., Ltd.

(21) Appl. No.: 10/388,561

(22) Filed: Mar. 17, 2003

(51) Int. Cl. B29C 45/00; C08J 5/00

(52) U.S. Cl. 264/328.1; 264/328.18; 264/331.19

(57) ABSTRACT

A novel method for manufacturing molded articles with improved temperature resistance by injection molding of a nylon 6T copolymer or its compound with a polypropylene resin as the improver is disclosed. A nylon 6T copolymer or its compound is mixed with a small amount (0.1% to 5%) of a polypropylene resin, and then injection molded at a suitable condition to form modified nylon 6T articles. The molded articles made by this novel method exhibit better temperature resistance as compared with those made by the conventional method.

### DETAILED DISCRIPTION OF THE INVENTION

Nylon is a common name for polyamides. Commonly used nylons are aliphatic polyamides such as nylon 6, nylon 66, nylon 610, nylon 612, nylon 11, and nylon 12. These aliphatic nylons possess a melting point below 260° C., and their temperature resistance is always below 250° C., thus they cannot be used in the field of high temperature resistant products such as connectors for surface mounting technology(SMT). Basically, the incorporation of aromatic ring into the polyamide structure may raise the melting point and enhance the temperature resistance. Wholly aromatic polyamides such as Kevlar and Nomex possess very high melting points, and it is impossible for them to be melt processed. Nylon 6T, poly (hexamethylene terephthamide), seems to be a high temperature resistant thermoplastic resin. The melting point of pure poly (hexamethylene terephthamide) is about 370° C. In experience, the aliphatic chain may decompose severely as the processing temperature is over 340° C. It is unfavorable for the pure poly (hexamethylene terephthamide) to be melt processed. Copolymerization is an effective to lower the melting point. The use of copolymerization to lower the melting point of nylon 6T is a practical molecular design.

The incorporation of some comonomers such as adipic acid, isophthalic acid, into poly (hexamethylene terephthamide ) can lower the melting point to a reasonable level.[ ] Typically, as the molar fraction of diacid comonomer in diacids is 30-40 mol %, the melting point of nylon 6T copolymers is around 310-320° C. A melting point of 310-320° C. lets the nylon 6T copolymers to be melt processable, and owns reasonably high temperature resistance. Some modified nylon 6T resins, such as Arlen of Mitsui and Polyphthalamide of Amoco, have been introduced to the market. They are easy to process by conventional molding machines. They also exhibit high temperature resistance due to their reasonably high melting point. The method of this invention is suitable for molding the nylon 6T copolymers such as copolymers of terephthalic acid, adipic acid and hexamethylenediamine, copolymers of terephthalic acid, isophthalic acid and hexamethylenediamine, and copolymers of terephthalic acid, adipic acid, isophthalic acid and hexamethylenediamine, etc.

The rigidity of materials at high temperature is an important property for some high temperature resistant applications. The use of glass fiber as the reinforcement can significantly enhance the rigidity of nylon 6T copolymers at high temperature. As the content of glass fiber increases, the mechanical properties such as strength and flexural modulus of the compounds of nylon 6T copolymers increase. In addition, their heat deflection temperature and dimension stability at high temperature are raised after the incorporation of glass fiber. Thus, some grades of commercial modified nylon 6T for some high temperature resistant applications contain suitable amount of glass fiber.

Some SMT electronic parts require a specification of suitable flame retardance for the materials. Typically, the materials used to produce some SMT connectors often require a V-0 rating of UL 94 flamability. The flame retardancy of the nylon 6T copolymers is only fair, generally, they can meet HB rating of UL 94 flamability. Thus, the use of flame retardants is often necessary for the nylon 6T copolymers for the application in some SMT electronic parts. However, if the amount of flame retardants is too much, some physical properties and the temperature resistance may be sacrificed. It is more useful to use a more effective flame retardant system such as a brominated compound in combination with an antimony oxide. The synergistic effect. between the brominated compound and the antimony oxide can reduce the used amount of the flame retardants. Examples of flame retardants are brominated organic compounds, brominated polystyrene, poly(bromostyrene), diantimony trioxide, diantimony pentaoxide, etc. and mitures thereof.

In some applications, the components require suitable toughness. Sometimes, the nylon 6T copolymers can not provide enough toughness. The use of tougheners or impact modifiers may be useful. The impact modifiers for common nylon resins are also suitable for the nylon 6T copolymers. Examples of impact modifiers are ethylene-acrylic acid copolymers, ethylene-methacrylic acid copolymers, maleic anhydride-graft-ethylene-propylene-diene rubber (maleic anhydride-g-EPDM), etc. and mitures thereof.

The method of this invention is suitable for the molding of the compounds of the nylon 6T copolymers. Depending on the application area, the nylon 6T copolymer compounds are derived from a nylon 6T copolymer, and/or glass fibers, and/or flame retardants, and/or impact modifiers, and/or colorants.

Nylons have a tendency to absorb water or moisture which leads to show some problems. The water absorption of nylon 66 immersed in water at room temperature for 24 hr is about 0.8%. In open air, nylon 66 parts absorb humidity significantly. This let the nylon 66 parts blister at high temperature due to the evaporation of the absorbed water. The water absorption of nylon 6T copolymers immersed in water at room temperature for 24 hr is about 0.2 to 0.4% and lower than that of nylon 66. However, the absorption of humidity also causes the blistering problem for nylon 6T copolymer parts. Typically, the molded parts of Arlen CH230NK of Mitsui Chemicals, Inc. exhibit different temperature after exposure to the air. The just made parts can sustain a temperature of 260° C. without blistering, and they appear to blister significantly at 270° C. However, if the molded parts expose to the air for several days, their temperature resistance is lowered, blistering problem may be observed at 240° C. In other words, the absorption of humidity reduce the temperature resistance of nylon 6T copolymers. If the absorption of humidity can be retarded, the temperature resistance of nylon 6T copolymers can be improved to some extent.

In this invention, a polypropylene resin is used as an improver to decrease or retard the absorption of humidity of nylon 6T copolymers. For example, the nylon 6T copolymer or nylon 6T copolymer compound in the pellet form is mixed with a polypropylene in pellet form, and then the mixture is injection molded under suitable conditions. The molded parts made by this novel method exhibit lower water absorption and exhibit higher temperature resistance. Comparing with the convention method, the nylon 6T copolymer molded parts produced by the method of this invention exhibit better temperature resistance. The content of polypropylene used can be 0.1 to 5.0%, and preferably 0.5 to 2.0%.

In this invention, a novel method for manufacturing molded articles with improved temperature resistance by injection molding of a nylon 6T copolymer or its compound with a polypropylene resin as the improver is disclosed. A nylon 6T copolymer or its compound is mixed with a small amount(0.1% to 5%) of a polypropylene resin, and then injection molded at a suitable condition to form modified nylon 6T articles. The molded articles made by this novel method exhibit better temperature resistance as compared with those made by the conventional method.

### EXAMPLES

The examples which follow are illustrative of the present invention and are not intended to limit the scope, which is defined by the claims.

### Example 1

A nylon 6T copolymer compound Arlen CH230NK in the pellet form supplied by Mitsui Chemicals, Inc. was mixed with various amounts of a polypropylene in pellet form in a mixer. The obtained pellet mixtures were injection molded into test specimens at cylinder temperatures of 310-325° C. (C1: 310° C.; C2: 315° C.;C3: 320° C.; Nozzle:325° C.) and at a mold temperature of 120° C. The mechanical properties of the test specimens were measured. The test specimens conditioned in a humid oven of relative humidity at 40° C. for 96 hr. Afterwards, the water absorption and the reflow temperature that the conditioned test specimens can sustain were determined. The test results are summarized in Table. It can be seen that the mechanical properties are not sacrificed too much after the addition of the polypropylene improver as shown in Table 1. The use of polypropylene as the improver is obvious. As the content of polypropylene increases, the water absorption decreases, and the conditioned test specimens can sustain higher reflow temperature. Thus, the temperature resistance can be improved by the presence of polypropylene resin.

TABLE 1
Mechanical properties, water absorption and reflow temperature
resistance of the test specimens.

| | | Content off PP | | | |
|---|---|---|---|---|---|
| | % | 0 | 0.5 | 1.0 | 2.0 |
| Flexural | MPa | 233 | 231 | 225 | 220 |
| strength | | | | | |
| Flexural | MPa | 12,200 | 12,000 | 12,000 | 11,700 |
| modulus | | | | | |
| Fracture energy | mJ | 46 | 47 | 44 | 43 |
| Water | % | 2.01 | 1.95 | 1.84 | 1.73 |
| absorption | | | | | |
| Reflow | 250° C. | ◯ | ◯ | ◯ | ◯ |
| Temperature | | | | | |
| | 255° C. | 100% | 80% | 50% | ◯ |
| | 260° C. | 100% | 100% | 100% | 100% |

◯: No change was observed.
The percentage indicates the fraction of blistering specimens.

### Example 2

Arlen CH230NK pellets and polypropylene pellets of different ratios were mixed in a mixer. The obtained pellet mixtures were injection molded under the condition as described in EXAMPLE 1 into pin header products. The products were exposed in the open air for 100 days, and their temperature resistance were evaluated. The test results are shown in Table 2. It can be seen that the temperature resistance can be improved significantly by the presence of polypropylene resin. A small amount of polypropylene can increase the temperature resistance by about 10° C. However, if the content of polypropylene is too high, such as 5%, the demolding becomes a problem, deformation of the products may occur.

TABLE 2
Temperature resistance of the pin header products.

| Content of | Reflow Temperature (° C.) | | | | | | |
|---|---|---|---|---|---|---|---|
| polypropylene (%) | 230 | 240 | 250 | 260 | 270 | 280 | 290 |
| 0 | ◯ | Δ | X | X | X | X | X |
| 0.5 | ◯ | ◯ | Δ | X | X | X | X |
| 1 | ◯ | ◯ | ◯ | Δ | X | X | X |
| 2 | ◯ | ◯ | ◯ | Δ | X | X | X |

◯: No change
Δ: Lightly blistering (within 10%)
X: Severely blistering or severe deformation

What is claimed is:

1. A method for manufacturing molded parts with improved temperature resistance by injection molding of a nylon 6T copolymer or its compound with a polypropylene resin as the improver.

2. A method according to claim 1 wherein the nylon 6T copolymer is a copolymer of terephthalic acid, adipic acid and hexamethylenediamine, copolymers of terephthalic acid, isophthalic acid and hexamethylenediamine, and copolymers of terephthalic acid, adipic acid, isophthalic acid and hexamethylenediamine, etc.

3. A method according to claim 1 wherein the nylon 6T copolymer compound is comprised of a nylon 6T copolymer, and/or glass fiber, and/or flame retardants, and/or an impact modifier, and/or a colorant.

4. A method according to claim 1 wherein the polypropylene content is 0.1% to 5%, and preferably 0.2% to 2%.
